(19) United States
(12) Patent Application Publication
(10) Pub. No.: US 2009/0011624 A1
(43) Pub. Date: Jan. 8, 2009

(54) Electric Connector

(76) Inventor: Haruki Yamazaki, Kanagawa (JP)

Correspondence Address: HARRINGTON & SMITH, PC, 4 RESEARCH DRIVE, Suite 202, SHELTON, CT, 06484-6212, US

(21) Appl. No.: 11/886,251

(22) PCT Filed: Mar. 14, 2006
(86) PCT No.: PCT/JP2006/304990

§ 371 Date: Apr. 24, 2008

(30) Foreign Application Priority Data
Mar. 15, 2005 (JP) 2005-073639

(51) Int. Cl. H01R 13/648

(52) U.S. Cl. 439/99

(57) ABSTRACT

The deterioration of the signal characteristic of a differential transmission connector is improved. The connector connected electrically with a plurality of cables each including a pair of signal lines and a pair of drain lines includes a pair of adjacent signal contactors connected with the pair of signal lines of the cable, a ground contactor connected with at least one drain line of the cable, a carrier on which the pair of signal contactors and the ground contactor are alternately arranged on the same plane in a line in the width direction perpendicular to the axial direction of the cable, and a first metal shell covering at least a part of the ground contactor, a part of the signal contactors and a part of the carrier. The connector is characterized in that the first metal shell has at least one ground contactor and a first contact.

### TECHNICAL FIELD

The present invention concerns a connector capable of electrically connecting differential transmission cables, and pertains to a connector that provides an excellent high speed signal characteristic.

### BACKGROUND ART

In recent years, along with the increase in information volume, and the increase in information transmission speed, a data transfer standard called “serial ATA” has been the mainstream interface between devices that are accessories to personal computers and the like. A serial transmission method refers to a method where information is transmitted 1 bit at a time using one transmission path, and since the number of signal wires is low, interference between signal wires does not readily occur, so such a method has the characteristic of being advantageous for increasing speed. Additionally, from the standpoint of signal voltage, it is advantageous because the voltage can be set low, around plus or minus 250 mV, and further, resistance to external noise is improved by utilizing differential transmission, in which the original signal and a signal which has its polarity reversed from said signal are transmitted through two signal wires simultaneously as a differential pair. Because of this, in said transmission method, 2 lines times 2 groups, that is, 4 signal wires are needed. However, along with the further increase in the volume of information, the reality is that speeding up of signal transfer speed and an increase in the number of signal wires is being sought for information communication henceforward, and thereby the miniaturization of the spaces between signal wires has become inevitable, so a task will be to improve the degradation of signal characteristics between signal wires that arises due to crosstalk caused thereby.

FIG. 4 shows a wiring diagram for a differential transmission connector from Patent Citation 1, and it discloses a structure wherein the degradation of signal characteristics is improved by the use of a plurality of differential transmission cables. Herebelow, the structure of said connector shall be explained with reference to FIG. 4.

FIG. 4 shows a plurality of differential transmission cables, and one of these cables includes one pair of signal wires 45 and one pair of drain wires 43. The state of array of the wiring inside each cable is such that one drain wire is placed on each side of one pair of neighboring signal wires 45, and they are aligned in a direction perpendicular to the axial direction of the cable. As a result, when a plurality of cables is arrayed, the state of the array is such that one drain wire is placed on the outermost end of one side, then a pair of neighboring signal wires, a pair of neighboring drain wires, and a pair of neighboring signal wires is placed alternately, and finally one drain wire is placed at the outermost end of the other side.

Regarding the drain wires within the array, each of the outermost drain wires is connected directly to a metallic shell 40, and the two other drain wires, neighboring each other, are connected sharing one corresponding ground electrical contact. Additionally, regarding the neighboring signal wires forming pairs within the array, they are each connected to one of two corresponding signal contacts.

The metallic shell 40 plays the role of an electric shield by covering each of the electric contacts that connect with each of the corresponding wires, thereby improving the impedance characteristic of the signal wires. Looking at the wiring relationship between the metallic shell 40 and the wires, since each of the drain wires 43 on the outermost ends of the array are connected directly to the metallic shell 40 without the mediation of an electrical contact, the invention according to Patent Citation 1 gives rise to an effect that contributes to the miniaturization of the spaces between signal wires by making at least two of the electrical contacts that were conventionally placed so as to correspond to each of the wires unnecessary.

Patent Citation 1: Japanese Patent Application No. 2004-198208

### DISCLOSURE OF THE INVENTION

### Problems to be Solved by the Invention

Patent Citation 1 shows an excellent impedance characteristic between signal wires, but if cases where the number of signal wires have realistically increased are considered, the aforementioned array of wires would increase in width, so that a plurality of drain wires (ground contacts) that are not on the outermost ends of the array will not connect with the metallic shell. In order to maintain excellent electrical stability, it is desirable that all drain wires (ground contacts) maintain a potential of 0 by having a point in contact with the metallic shell, thereby preventing one cause of crosstalk between signal wires. Therefore, the purpose of the present invention is to provide a connector that prevents the occurrence of crosstalk in differential transmission connector wiring, and provide an electrically stable connector.

### Means for Solving the Problem

(1) In order to achieve the abovementioned purpose, the connector according to the present invention is a connector for electrically connecting a plurality of cables, each cable comprising a pair of signal wires and a pair of drain wires, the connector comprising a pair of neighboring signal contacts, the signal contacts being for connection to a pair of signal wires of the cable, a ground contact, the ground contact being for connection to at least one drain wire of the cable, a carrier comprising the pair of signal contacts and the ground contact, the signal contacts and the ground contact being arrayed in the same plane and in a single file, the width direction of the array being perpendicular to the axial direction of the cable, and a first metallic shell for covering at least one part of the signal contacts, at least one part of the ground contact, and at least one part of the carrier, wherein the first metallic shell comprises a first contact point, the first contact point contacting at least one ground contact.

(2) Additionally, it is desirable for the abovementioned first contact point to form a contact portion which contacts the ground contact via a tongue, the tongue being elongated from the first metallic shell.

(3) Further, the connector according to the present invention is capable of fitting together with a connector as in (1) or (2), comprising arrayed connectors which correspond to the abovementioned signal contacts and ground contact, such that an electrical connection is made when the connectors are fitted together, and a second metallic shell comprising at least one second contact point, the second contact point contacting the first metallic shell when the connectors are fitted together.

(4) Additionally, it is desirable for the aforementioned second contact point to form a contact via a tongue portion which contacts the first metallic shell, the tongue being elongated from the second metallic shell.

(5) Additionally, it is desirable for the aforementioned second metallic shell to comprise a plurality of legs for electrical connection to ground wiring of a printed circuit board, the second metallic shell not having a contact portion on the surface thereof which contacts the printed circuit board, other than the plurality of legs.

(6) Further, the connector according to the present invention is electrically connected to a plurality of cables, each cable comprising a pair of signal wires and a pair of drain wires, the connector comprising two sets of a pair of neighboring signal contacts, the signal contacts being for connection to a pair of signal wires of the cable, three ground contacts, the ground contacts being for connection to one or two drain wires of the cable, a carrier comprising the pair of signal contacts and the pair of ground contacts, the signal contacts and the ground contacts being arrayed in the same plane and in a single file, the width direction of the array being perpendicular to the axial direction of the cable, and a first metallic shell for covering at least one part of the signal contacts, at least one part of the ground contacts, and at least one part of the carrier, wherein, the first metallic shell comprises elongated tongues, the tongues corresponding to each of the ground contacts, and forms contacts, the contacts contacting the ground contacts via the tongues.

### EFFECTS OF THE INVENTION

(1) Since, in the invention according to claim 1, the first metallic shell comprises a first contact point, the first contact point contacting at least one ground contact, said at least one ground contact becomes connected to the metallic shell and thus has a potential of approximately 0. Whereby, the impedance characteristic can be improved by maintaining a predetermined potential difference between the signal wires.

(2) Since the invention according to claim 2 forms a contact portion via a tongue, the tongue being elongated from the first metallic shell, a contact point can be formed with a predetermined ground contact by using one portion of the first metallic shell, by, for example, folding in a tongue formed by elongation from an edge portion of the first metallic shell.

(3) Since, in the invention according to claim 3, when fitted together with a connector according to claim 1 or 2, the second metallic shell has at least one second contact point, the second contact point contacting the first metallic shell, a contact portion is formed between the first metallic shell and the second metallic shell when the connectors are fitted together, and if the second metallic shell is grounded, then the first metallic shell can also be maintained at a potential of close to 0.

(4) Since the invention according to claim 4 forms a contact via a tongue which contacts the first metallic shell, the tongue being elongated from the second metallic shell, the first metallic shell and the second metallic shell can be maintained at the same electrical potential by readily forming a contact point with the first metallic shell by utilizing one portion of the second metallic shell, using a method wherein one portion of the second metallic shell is notched, leaving a contact portion, and is folded into the inner direction of the second metallic shell.

(5) Since the invention according to claim 5 does not have a contact portion on the surface thereof which contacts the printed circuit board, other than a plurality of legs, the plurality of legs connect to the ground line of the printed circuit board, making the potential of the entire second metallic shell approximately 0, and does not influence the printed circuit board electrically.

(6) Since, in the invention according to claim 6, the first metallic shell comprises elongated tongues, the tongues corresponding to each of the ground contacts, and forms contacts, the contacts contacting the ground contacts via the tongues, even if the number of wires increases, and even if the array grows alternately from one end, in the order of a ground contact and then one pair of neighboring signal wire contacts and so on, contact points can easily be formed between the first metallic shell and all of the ground contacts merely by forming a tongue or the like from the first metallic shell corresponding to the form of the ground contact, and making this protrude.

### BRIEF EXPLANATION OF THE DRAWINGS

FIG. 1 is a block diagram of the cable-side connector and the printed circuit board-side connector of the present invention.

FIG. 2 is an assembly and wiring diagram of the cable-side connector according to the present invention.

FIG. 3 is an exploded view of the printed circuit board-side connector according to the present invention.

FIG. 4 is a conventional connector wiring diagram of a differential transmission cable.

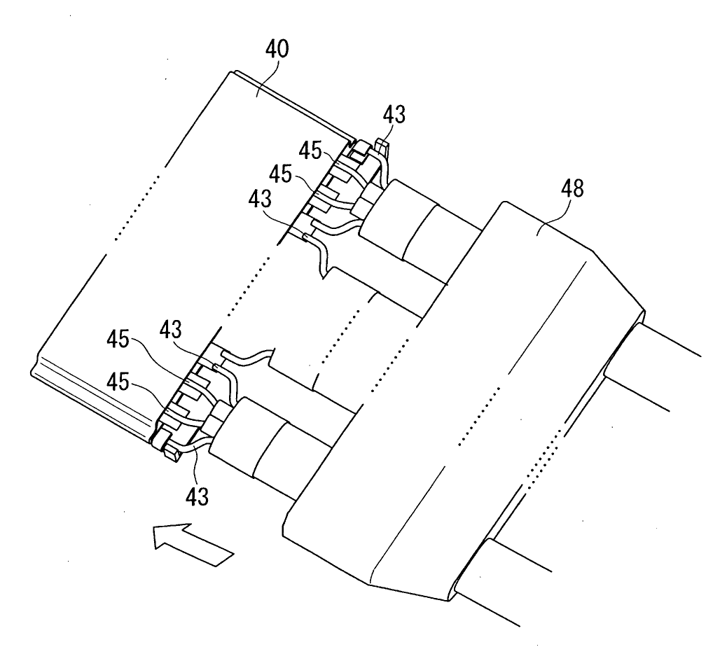

### EXPLANATION OF REFERENCE NUMBERS

1 . . . First metallic shell
1a . . . Tongue
2a . . . Ground contact
2a′ . . . Ground contact
2b . . . Signal contact
2b′ . . . Signal contact
3 . . . Carrier
4 . . . Differential transmission cable
4a . . . Drain wire
4b . . . Signal wire
5 . . . Second metallic shell
5a . . . Tongue
5a′ . . . Leg
7 . . . Carrier
8 . . . Printed circuit board
9 . . . Border portion

### BEST MODE FOR EMBODYING THE INVENTION

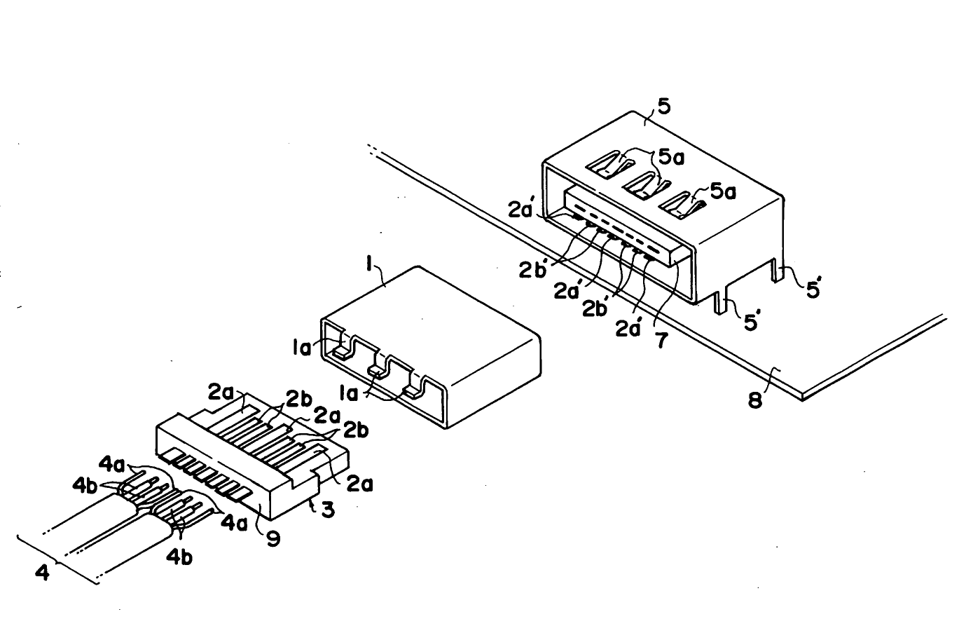

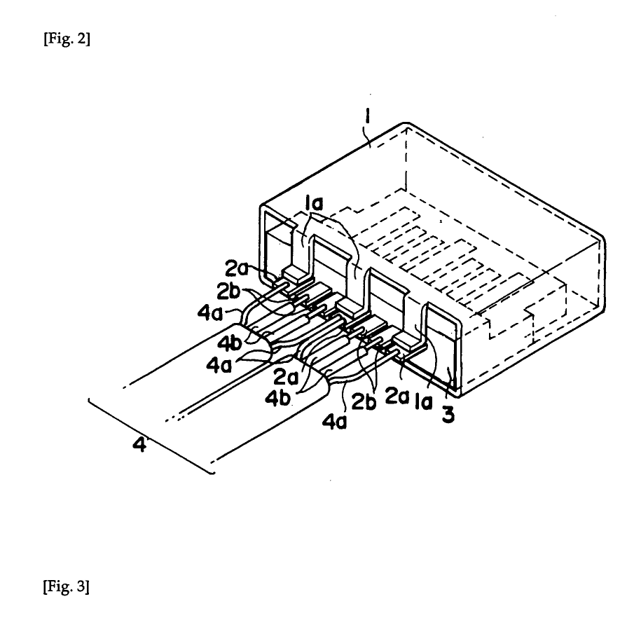

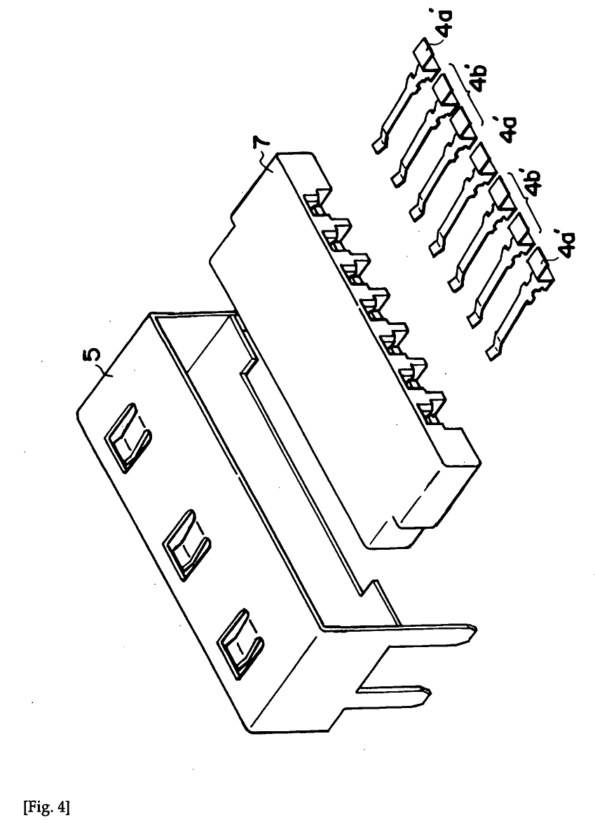

FIG. 1 is a block diagram showing the differential transmission cable-side connector and the printed circuit board-side connector of the present invention. FIG. 2 is a wiring diagram and an assembly diagram of the cable-side connector. FIG. 3 is an exploded view of the printed circuit board-side connector.

The cable-side connector according to the present invention shall be explained with reference to FIGS. 1 and 2. Said cable-side connector has a structure such that it electrically connects with two parallel differential transmission cables 4, and said differential transmission cable 4 internally comprises one pair of signal wires 4b and one pair of drain wires 4a. Additionally, said connector comprises the abovedescribed differential transmission cable 4, two pairs of signal contacts 2b, three ground contacts 2a, a carrier 3, and a first metallic shell 1.

Herebelow, each of the constituent elements shall be described.

The signal contacts 2b form neighboring pairs, and are placed so as to sandwich the central ground contact 2a, and are connected so that each contact corresponds with one of the signal lines 4b which form two pairs in the abovedescribed two cables 4. Additionally, the three ground contacts 2a are positioned so that two of them are on the outermost ends of the array, one on each end, and are each connected to one of the abovedescribed drain wires 4a of the cable, and further, the remaining one contact is placed in the center of the array so as to be sandwiched by one pair of signal contacts 2b, and is connected to said one remaining ground contact 2a by sharing two neighboring drain wires.

Next, the carrier 3 comprises a surface whereon are placed ground contacts 2a and one pair of neighboring signal contacts 2b, and each of the contacts 2a, 2b are arranged alternately in a single line in the width direction, perpendicular to the axial direction of the abovedescribed cable, so that one end protrudes through the border portion 9 of the carrier 3.

The first metallic shell 1 is in the shape of a hollow rectangular parallelepiped having open surfaces facing each other, and three tongues 1a are elongated from the edge.

Next, the assembly of the cable-side connector shall be explained.

After wiring each of the contacts and the cables, the carrier 3 is inserted into the hollow interior of the first metallic shell 1 from one of the open surfaces, said carrier 3 is housed and retained due to contact friction at the contact surface between the inner surface of the first metallic shell 1 and the carrier 3, and the position is suitably determined. In the interior of the first metallic shell, since there is a spatial distance separating the array surface of the abovedescribed contacts and the inner surface of the first metallic shell 1 that opposes said surface, after the carrier 3 is positioned in a predetermined position in the interior of the first metallic shell 1, the abovedescribed tongues 1a are put into contact on the ground contacts 2a in the vicinity of the contact points between each of the ground contacts 2a and the drain wires 4a, and thereby, the drain wires 4a of the cable 4 and the first metallic shell 1 are electrically connected (see FIG. 2). Further, when the assembly of said connector has been completed, the first metallic shell 1 covers at least one portion of each of the contacts 2a, 2b and at least one portion of the carrier 3, and reduces crosstalk between each of the signal wires by realizing an electrical shield effect. The wiring and the assembly of the cable-side connector is performed as explained above, and it is obvious to those skilled in the art that one could perform further processing by covering the first metallic shell 1 with an insulating material.

Next, the printed circuit board-side connector shall be explained with reference to FIG. 1.

Said connector is structured so as to connect electrically when fitted together with a cable-side connector. Said connector comprises two pairs of neighboring signal contacts 2b′, three ground contacts 2a′, a carrier 7, and a second metallic shell 5.

Two pairs of neighboring signal contacts 2b′ and three ground contacts 2a′ are arranged on the surface of the carrier 7, and the order of their array is the same as the cable-side connector. When the connectors are fitted together, each of the contacts of the printed circuit board side connector correspond to and come into contact with the signal contacts 2b and the ground contacts 2a of the abovedescribed cable-side connector.

Additionally, the second metallic shell 5 is a hollow rectangular parallelepiped having opposing open surfaces, comprising four legs 5′ that are grounded on the printed circuit board 8, and three tongues 5a formed by notching one surface of the second metallic shell 5, and is fixed so as to maintain a spatial distance from the installation surface of the printed circuit board 8, via the four legs 5′. Therefore, the second metallic shell 5 connected to the printed circuit board 8 has an electrical potential of approximately 0. Additionally, since the second metallic shell 5 and the printed circuit board 8 are not in contact, there is no danger of exerting an electrical influence on the printed circuit board 8.

The assembly of the printed circuit board-side connector shall be explained with reference to FIGS. 1 and 3.

Similarly with the placement of each of the contacts on the carrier 3 of the cable-side connector, first, each of the contacts are inserted and placed on the carrier 7. Next, the carrier 7 is inserted through one of the open surfaces of the second metallic shell 5, said carrier 7 is housed and retained by contact friction at the contact surface between the inner surface of the second metallic shell 5 and the carrier 7, and the position is determined suitably. At this time, the array surface of the contacts is arranged so as to oppose the contact array surface of the cable-side connector when the connectors are fitted together. Next, said connectors are electrically connected to the ground wires of the printed circuit board 8 via the abovedescribed legs 5′, and each contact is electrically wired to a predetermined terminal of the printed circuit board side.

Next, the relation between the carrier 3 and the carrier 7 when the cable-side connector and the printed circuit board-side connector are fitted together shall be explained.

The cable-side connector is housed inside the second metallic shell 5 of the printed circuit board-side connector through the other open surface. The carrier 7 is housed within the space formed by the carrier 3 and the first metallic shell 1, and at that time, each of the contacts of the carrier 7 form contact points or contact surfaces with each of the corresponding contacts of the carrier 3, and the contacts of both sides are electrically connected.

Next, the relation between the first metallic shell 1 and the second metallic shell 5 when the cable-side connector and the printed circuit board-side connector are fitted together shall be explained.

The first metallic shell 1 is secured with a space separating it from the inner surface of the second metallic shell 5, but the first metallic shell 1 and the second metallic shell 5 have contact points or contact surfaces via the abovedescribed three tongues 5a elongated from the second metallic shell 5.

As described above, when the cable-side connector and the printed circuit board-side connector are fitted together, the drain wires of the differential transmission cable, each of the ground contacts of the cable-side and the printed circuit board-side connectors, the first metallic shell, and the second metallic shell are electrically connected, and are connected to the ground wiring on the printed circuit board, so a voltage of approximately 0 can be maintained.

Therefore, the connector of the present invention maintains the signal wire voltage at a predetermined potential, prevents the occurrence of crosstalk in the differential transmission connector wiring, and provides an electrically stable connector.

Additionally, as disclosed in Patent Citation 1, it is obvious that the number of electrical contacts can be reduced by connecting the outermost drain wires of the cable-side connector directly to the first metallic shell 1.

A mode of embodiment of the present invention has been explained, giving an example of an embodiment, but the present invention is not limited to the abovedescribed embodiment, and additions and modifications and the like can be made within the scope of the gist of the present invention.

1. A connector for electrically connecting a plurality of cables, each cable comprising a pair of signal wires and a pair of drain wires, the connector comprising:
a pair of neighboring signal contacts, the signal contacts being for connection to a pair of signal wires of the cable;
a ground contact, the ground contact being for connection to at least one drain wire of the cable,
a carrier comprising the pair of signal contacts and the ground contact, the signal contacts and the ground contact being alternately arrayed in the same plane and in a single file, the width direction of the array being perpendicular to the axial direction of the cable; and
a first metallic shell for covering at least one part of the signal contacts, at least one part of the ground contact, and at least one part of the carrier; wherein,
the first metallic shell comprises a first contact point, the first contact point contacting at least one ground contact.

2. A connector as in claim 1; wherein,
the first contact point forms a contact portion which contacts the ground contact via a tongue, the tongue being elongated from the first metallic shell.

3. A connector capable of fitting together with a connector as in claim 1, the connector comprising:
arrayed connectors which correspond to the signal contacts, the signal contacts being for connection to a pair of signal wires of a second cable; and ground contact, being for connection to at least one drain wire of the second cable, such that an electrical connection is made when the connectors are fitted together; and
a second metallic shell comprising at least one second contact point, the second contact point contacting the first metallic shell when the connectors are fitted together.

4. A connector as in claim 3; wherein,
the second contact point forms a contact via a tongue portion which contacts the first metallic shell, the tongue being elongated from the second metallic shell.

5. A connector as in claim 4; wherein,
the second metallic shell comprises a plurality of legs for electrical connection to ground wiring of a printed circuit board, the second metallic shell not having a contact portion on the surface thereof which contacts the printed circuit board, other than the plurality of legs.

6. A connector for electrically connecting a plurality of cables, each cable comprising a pair of signal wires and a pair of drain wires, the connector comprising:
two sets of a pair of neighboring signal contacts, the signal contacts being for connection to a pair of signal wires of the cable;
three ground contacts, the ground contacts being for connection to one or two drain wires of the cable;
a carrier comprising the pair of signal contacts and the ground contacts, the signal contacts and the ground contacts being alternately arrayed in the same plane and in a single file, the width direction of the array being perpendicular to the axial direction of the cable; and
a first metallic shell for covering a least one part of the signal contacts, at least one part of the ground contacts, and at least one part of the carrier; wherein,
the first metallic shell comprises elongated tongues, the tongues corresponding to each of the ground contacts, and forms contacts, the contacts contacting the ground contacts via the tongues.
